(19) United States
(12) Patent Application Publication
(10) Pub. No.: US 2024/0260722 A1
(43) Pub. Date: Aug. 8, 2024

(54) Anal Inserted Sacral Region Body Adornment

(71) Applicant: Tail and Talon Fantasies LLC, Chesterfield, VA (US)

(72) Inventor: Gregory David Goszinski, Chesterfield, VA (US)

(73) Assignee: Tail and Talon Fantasies LLC, Chesterfield, VA (US)

(21) Appl. No.: 18/541,965

(22) Filed: Dec. 15, 2023

Related U.S. Application Data
(60) Provisional application No. 63/432,867, filed on Dec. 15, 2022.

(51) Int. Cl. A44C 15/00; A61H 1/00; A61H 19/00; A61H 21/00

(52) U.S. Cl. CPC A44C 15/0045; A61H 1/00; A61H 19/32; A61H 21/00; A61H 2201/1647; A61H 2201/165

(57) ABSTRACT

An ornamental device satisfies two aspects of sexual experiences by including an anal insertion device and more anatomically correct animalistic ornamentation. An ornamentation device combining these two aspects of sexual exploration is described. The ornamentation device may have an insertion device configured for inserting into an anal cavity of a person, a sacral stem connected to the insertion device, and an adornment connected to the sacral stem.

### FIELD OF THE INVENTION

An anal insertion device comprising ornamentation is described. The ornamentation may comprise, a tail-like feature, jewelry, or costume accessories. That ornamentation may be located at the sacral region of the body of the user of the device. The device thereby may provide both adult pleasure and a more preferred or natural location for any tail-like ornamentation on the human body.

### BACKGROUND

In human fetal development, an embryonic tail will grow and develop into the coccyx or the tailbone. This tailbone is a bone located at the end of the spine, below the sacrum, in a sacral region of the body. In rare circumstances, however, the embryonic tail doesn't disappear and the baby is born with it. This would be a true human tail. If humans had tails, they would be located in the sacral region, not near the anus.

Nonhuman animals with tails have them connected or extending from anywhere between the sacral region to the sacrum. To simulate a human tail, people connect tails to their sacral region by using belts, straps, or clips on their clothing or other costume.

Some anal insertion devices comprise a simulated tail directly connected to an external portion of an insertion device, but the tails on these devices are located in an unnatural and anatomically incorrect location at the anus or rectum.

For example, a butt plug or anal plug is a common adult pleasure device on the market that offers a body adornments. Those adornments are directly attached to an insertion device stem of the plug therefore locating the adornment just outside the anus.

Another similar product is often called a waist band tail and allows the wearer to have a adornment that appears as an animalist tail featured at the sacral region of the body by use of a belt and/or strapping.

There is a need for a device that is comprised of an anal insertion portion and a simulated tail, jewelry, costume accessories, or other ornamentation to be displayed on a human body at the sacral region without belts, straps, costumes, or other clothing.

### SUMMARY

People enjoy sexual exploration. Two aspects of this include inserting objects in the anus and dressing up as various animals. An ornamentation device includes combining these two aspects of sexual exploration. For example, embodiments of ornamentation device may comprise an insertion device and a faux or real animal tail. Further embodiments of the ornamentation device comprising an insertion device configured for inserting into an anal cavity of a person, a sacral stem connected to the insertion device, and an adornment connected to the sacral stem. The sacral stem extends from the insertion device within the anus to the sacral region of the person where a tail would be located in an animal or to a location of the anatomy if a person had as tail. Thus, the ornamentation device may be both an anal insertion device and an anatomically correct tail adornment device. Other adornments may be attached to the ornamentation device as desired. In some embodiments, the adornment may be reversibly connected to the ornamentation device so that the adornment may be changed as desired. Therefore, an ornamentation device kit may comprise a insertion device configured for inserting into an anal cavity of a person, a sacral stem connected to the insertion device, and a plurality of adornments that are reversibly connected to the sacral stem.

Embodiments of the ornamentation device comprise an insertion device stem connected between the insertion device and the sacral stem. For example, the insertion device stem may be connected on a first end of the insertion device stem and connected to the sacral stem on a second end of the insertion device stem.

Further embodiments of the ornamentation device may comprise an adornment mount connected to the top portion of the sacral stem. The top portion of the sacral stem will be in the sacral region of the person when the device is in use. In such embodiments, the adornment is connected to the adornment mount.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of components, parts, techniques and steps are disclosed. Each of these has individual benefits and each can also be used in conjunction with one or more, or in some cases, all of the other disclosed embodiments and techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

### BRIEF DESCRIPTION OF THE FIGURES

FIG. 1 depicts an embodiment of an anal insertion device;

FIG. 2 depicts a profile view of a human body indicating the sacral region;

FIG. 3 depicts a profile view of the human body wearing the anal insertion device of FIG. 1.

### DESCRIPTION OF THE INVENTION

People enjoy a varied sexual experience. One aspect of a varied sexual experience may include inserting objects, such as, but not limited to, anal plugs or butt plugs, in their own or their partners anus. These anal plugs are inserted into the anus and are intended to enhance sexual sensations, either during masturbation, foreplay, or intercourse. Anal plugs come in various shapes, sizes, and materials to accommodate different preferences and levels of experience.

Further to enhance their sexual experiences, some people chose to adorn themselves with animal features such as, but not limited to ears and tails. Others are attracted to people wearing these adornments. An embodiment of a sexual device or an ornamentation device combines these two aspects of sexual exploration into one device and, in some embodiments, provides an adornment, such as a tail, in an anatomically correct position. For example, embodiments of ornamentation device may comprise an insertion device (butt plug or anal plug) and a faux or real animal tail, for example. The plug provides physical stimulation while the tail may provide visual stimulation.

Further embodiments of the ornamentation device comprising an insertion device configured for inserting into an anal cavity of a person, a sacral stem connected to the insertion device, and an adornment connected to the sacral stem. The sacral stem extends from the insertion device within the anus to the sacral region of the person where a tail would be located on an animal or to a location of the anatomy if a person had as tail. Thus, the ornamentation device may be both an anal insertion device and an anatomically correct tail adornment device. The insertion device may be tapered to increase the wearer's comfort. In a preferred embodiment, the entire insertion device is smooth; however, it can range in shape and size depending on the users desired preference and may comprise of one or more bulbous, knobbed, textured, or ridged sub-regions. An insertion device may be designed to look like a penis, while some are ribbed or wavy. Many have a thin tip which is wider in the middle, a notch to hold it in place once it is inserted, and a flared base to prevent complete insertion into the rectum. Some plugs have an egg-shaped penetrative part. In one embodiment, the insertion device is tapered on one end and the opposite end is egg shaped. The insertion device may further comprise an integrated vibrator.

Other adornments may be attached to the ornamentation device as desired. For example, the adornment may be one of a tail-like feature, feline tails, canine tails, primate tails, jewelry, and costume accessories. In some embodiments, the adornment may be reversibly connected to the ornamentation device so that the adornment may be changed as desired. Therefore, an ornamentation device kit may comprise an insertion device configured for inserting into an anal cavity of a person, a sacral stem connected to the insertion device, and a plurality of adornments that are reversibly connected to the sacral stem. The

Embodiments of the ornamentation device comprise an insertion device stem connected between the insertion device and the sacral stem. For example, the insertion device stem may be connected on a first end of the insertion device stem and connected to the sacral stem on a second end of the insertion device stem.

Further embodiments of the ornamentation device may comprise an adornment mount connected to the top portion of the sacral stem. The top portion of the sacral stem will be in the sacral region of the person when the device is in use. In such embodiments, the adornment is connected to the adornment mount.

The sacral stem extends from the anus to the sacral region of the body. The sacral stem by be any desired shape that accomplishes this goal. For example, the sacral stem may have a curved shape. In some of these embodiments, the curved shape of the sacral stem is configured to conform to the curvature between the anus and the sacral region. Further, the curved shape may be configured to reside within the intergluteal cleft of the user. Though other shapes may also reside within the intergluteal cleft. The sacral stem having both a curvature similar to the sacral curve of the human body and residing comfortably within the intergluteal cleft will provide a natural, anatomically correct appearance. Also, with the sacral stem resides within the intergluteal cleft, the tail-like feature, jewelry, costume accessory, or other ornamentation can appear to be connected directly to the body.

The ornamentation device, the adornment mount, the sacral stem, the insertion device stem, and the insertion device may be constructed of any suitable material. For example, all of the parts or some of the parts of the ornamentation device may be constructed from, but not limited to, aluminum, stainless steel, silicone, rubber, plastic, other metal, glass, wood, other material with sufficient strength to allow insertion of the device and to maintain the desired location of the adornment, or combinations thereof, for example. For example, the insertion device, the insertion stem, and the sacral stem may be integral components. These components may be molded in one piece, for example. Alternatively, the entire ornamentation device except the adornment, including the insertion device, the insertion stem, the sacral stem, and an adornment mount may be integral components.

Therefore, as shown in the figures, embodiments of the ornamentation device 10 comprise of the insertion device 11 for inserting into an anal cavity of a person, an insertion device stem 12 connected to the insertion device on a first end 12A of the insertion device stem; a sacral stem comprising of a bottom portion 13A that is connected to the second end 12B of the insertion device stem, and at least one of an adornment mount 14 or an adornment 15 connected to the upper portion 14B of the sacral stem.

This device allows the wearer to have any variety of adornment options, including adornments that are similar to (or appear to be) animalistic tails, displayed at the sacral region of their body as opposed to the anus. The adornment device accomplishes this without the need for waist bands, belts, or similar strapping mechanisms while maintaining the adult pleasures of an anal inserted device.

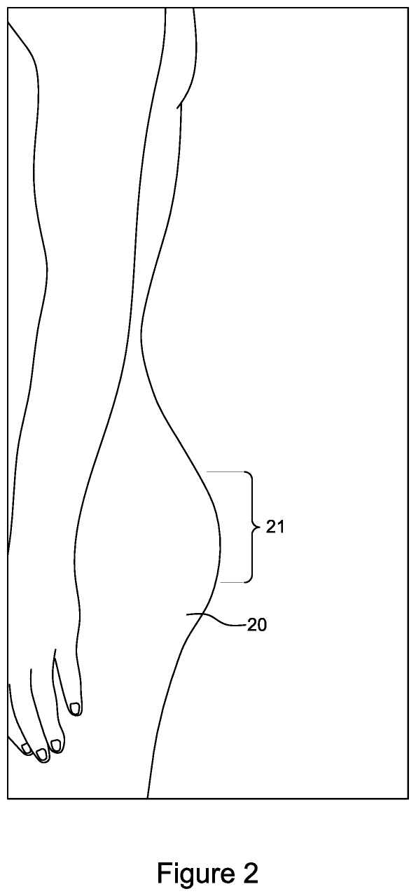

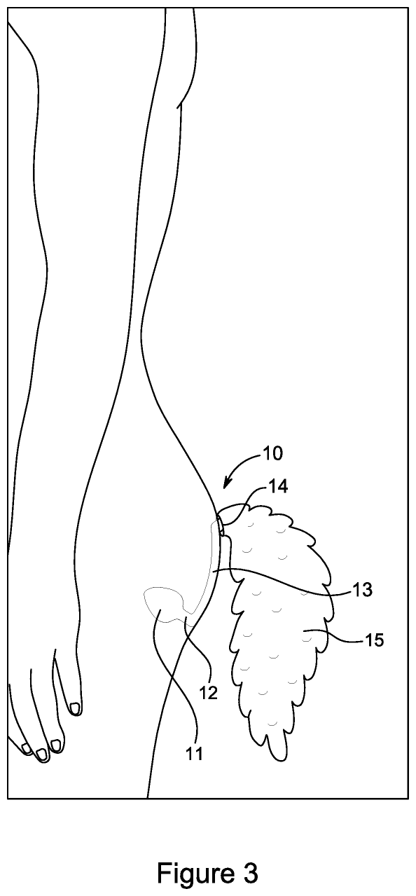

As shown in FIG. 3, embodiments or the ornamentation device fundamentally locates any adornment in the sacral region 21 (shown in FIG. 2) above the anus 20 of the human body. The ornamentation device shown in FIG. 3 comprises a bulb 11 inserted into an anal cavity with the bulb stem 12 extending from the bulb 11 out of the anal cavity and connected to the sacral stem 13. The sacral stem 13 extends generally in a vertical direction and may rest in and/or along the Intergluteal cleft to the sacral region 21.

An adornment 15 or other device may be connected to the adornment mount 14; thus creating a mounting point for a variety of adornments, including adornments that are similar to or appear to be an animalistic tail, at the lower sacral region 21 of the body instead of the anus 20 (as shown in FIG. 2). This device creates a more comfortable experience for the wearer and creates a better overall aesthetic without the need for waist bands or belts while also maintaining the adult pleasure of an anal inserted device and improving hygienic qualities.

As the end of the bulb 11 transitions to a insertion stem 12 that is smaller in diameter than the bulb 11. This component that is similar to, or functions the same as, may be straight and the length would be about the average length of the adult anal canal so that the bulb 11 can rest in the rectum and allow for the bulb stem 12 to extend out of the anal cavity.

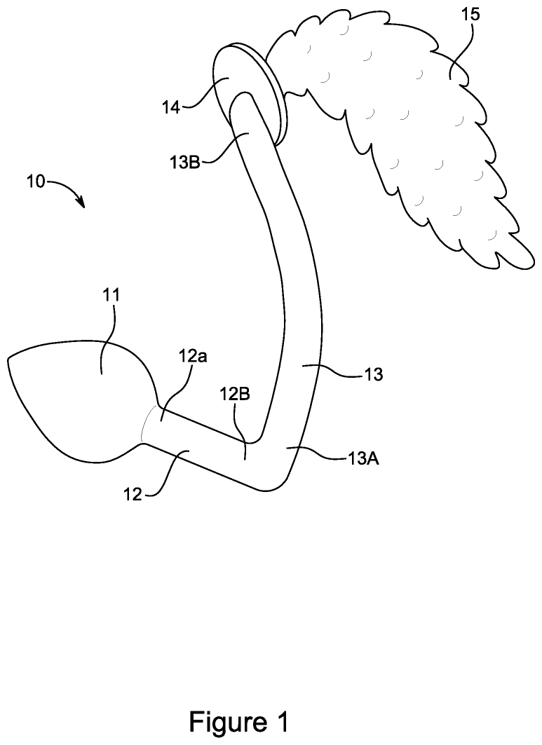

The stem 12 is connected to the sacral stem in FIG. 1 and FIG. 3 would be external to the human body. The sacral stem 13 to travel up the integral cleft of the human body. As the sacral stem 13 reaches the sacral region 21 of the human body, The adornment 15 and/or the adornment mount 14 are located.

The adornment mount 14 and/or the adornment 15 may be connected by any means including, but not limited to, can be attached by any known methods including, but not limited to, adhesive, clips, hook and loop connectors, screws, chemical bonding, welding, bolt, or integrally formed, for example.

There are a variety of adornment options, including adornments that are similar to or appear to be an animalistic tail and may be available in a range of options including but not limited to colors, textiles, length, and shapes.

Therefore, while embodiments of the invention are described with reference to exemplary embodiments, those skilled in the art will understand that variations and modifications can be affected within the scope of the invention as defined in the appended claims. Accordingly, the scope of the various embodiments of the present invention should not be limited to the above discussed embodiments and should only be defined by the following claims and all equivalents.

1. An ornamentation device, comprising:
an insertion device configured for inserting into an anal cavity of a person;
a sacral stem connected to the insertion device, wherein the sacral stem extends from the insertion device to the sacral region of the person; and
an adornment connected to the sacral stem.

2. The ornamentation device of claim 1, comprising an insertion device stem connected to the insertion device on a first end of the insertion device stem and connected to the sacral stem on a second end of the insertion device stem.

3. The ornamentation device of claim 1, comprising an adornment mount connected to the sacral stem in the sacral region of the person.

4. The ornamentation device of claim 3, wherein the adornment is connected to the adornment mount.

5. The ornamentation device of claim 1, wherein the adornment resembles a tail.

6. The ornamentation device of claim 1, wherein the adornment is a tail.

7. The ornamentation device of claim 1, wherein the insertion device is tapered on one end and the opposite end is egg shaped.

8. The ornamentation device of claim 1, wherein the sacral stem has a curved shape.

9. The ornamentation device of claim 1, wherein the curved shape of the sacral stem is configured to conform to the curvature between the anus and the sacral region.

10. The ornamentation device of claim 9, wherein the sacral stem is configured to reside within the intergluteal cleft.

11. The ornamentation device of claim 10, wherein the adornment is one of a tail-like feature, jewelry, and costume accessory.

12. The ornamentation device of claim 2, wherein at least one of the insertion device, the insertion stem, and the sacral stem are made of silicone.

13. The ornamentation device of claim 2, wherein the insertion device, the insertion stem, and the sacral stem are integral components.

14. The ornamentation device of claim 13, wherein the insertion device, the insertion stem, the sacral stem, and an adornment mount are integral components.

15. The insertion device of claim 1, wherein the insertion device comprises an integrated vibrator.
